(19) United States
(12) Patent Application Publication
(10) Pub. No.: US 2015/0045142 A1
(43) Pub. Date: Feb. 12, 2015

(54) MILLING PROCESS FOR ROUGHNESS ON GOLF CLUB FACE

(71) Applicant: Cobra Golf Incorporated, Carlsbad, CA (US)

(72) Inventors: Scott H. Moreira, San Diego, CA (US); Joshua G. Breier, Vista, CA (US); Christopher D. Harvell, Escondido, CA (US); Amber Frauhiger, San Diego, CA (US); Matthew R. Johnson, San Marcos, CA (US); Tim A. Beno, San Diego, CA (US)

(21) Appl. No.: 14/453,671

(22) Filed: Aug. 7, 2014

Related U.S. Application Data
(60) Provisional application No. 61/864,925, filed on Aug. 12, 2013.

(51) Int. Cl. A63B 53/04; B23C 3/13

(52) U.S. Cl. CPC A63B 53/047; B23C 3/13; A63B 2053/0479; A63B 2053/0445
USPC 473/330; 409/131

(57) ABSTRACT

The invention generally relates to a golf club in which the ball-striking face has a high surface roughness. The invention provides systems and methods for dual speed milling for improved surface roughness. In certain aspects, the invention provides a method of making a ball striking face for a golf club that includes obtaining a piece of material for use as a club head ball-striking face, milling a surface of the piece of material at a first speed, and milling the surface at a second speed.

This application claims the benefit of, and priority to, U.S. Provisional Application No. 61/864,925, filed Aug. 12, 2013, the contents of which are incorporated by reference.

### FIELD OF THE INVENTION

The invention generally relates to a golf club in which the ball-striking face has a high surface roughness.

### BACKGROUND

Many golfers wish they could shoot like the pros. They watch golf, and see the pros hit shots that fly to the green, land, and roll backwards into the hole. Golfers try to re-create those magnificent shots by practicing, practicing, and practicing. They also buy wedges and other clubs with features designed to maximize spin. For example, some golf clubs are designed to have a high surface roughness on the face of the club. However, golf rules prohibit surface roughness from exceeding 180 μinch for arithmetical mean roughness (Ra) and from exceeding 1000 μinch for maximum peak (Ry).

FIG. 1A shows Ra calculated using standard length l sampled from a mean line m on a roughness chart. The mean line m is laid on a Cartesian coordinate system in the direction of the x-axis, with magnification on the y-axis. Ra is given by (1/l )∫fxdx. FIG. 1B shows Ry determined using a standard length l sampled from the mean line m. The distance between the peaks and valleys is measured in the y direction.

Unfortunately, even where a golf club designer has created a golf club with a surface roughness that is taken right up to the limit imposed by USGA rules, some golfers—try as they might—still do not get the backspin they want and lack the control to have a ball land on the green and stop or even roll backwards.

### SUMMARY

The invention provides a method of milling a golf club face at two different speeds that produces a face in which Ra and Ry are both brought right up to the limit imposed by the rules, making an overall roughness that is higher than, and imparts more spin than, prior art clubs. The invention includes the insight that prior art manufacturing techniques coupled Ra to Ry such that changing one causes a consistent change in the other and that the limit of Ra is typically reached before reaching the limit of Ry. The invention provides a surface roughness manufacturing technique that allows for maximizing both Ra and Ry, thereby providing maximum surface roughness, and imparting the highest level of spin allowed under current equipment rules.

In certain aspects, the invention provides a method of making a ball striking face for a golf club that includes obtaining a piece of material for use as a club head ball-striking face, milling a surface of the piece of material at a first speed, and milling the surface at a second speed. The method may include programming a milling device to operate at a first setting that includes the first speed and to operate at a second setting that includes the second speed. The milling steps may include feeding the piece of material into the milling device and operating the milling device according to a program. The program may cause the milling device to alternate between the first speed and the second speed a plurality of times.

The milled piece of material may be used as a ball-striking face in a club head. In certain embodiments, the club head is for a wedge style golf club. In some embodiments, the ball striking face is a face insert that is attached to a club head body. Aspects of the invention provide a golf club head with a ball striking face made by the method described above.

Aspects of the invention provide a golf club head that has a main club head body with a heel end, a toe end, and a hosel extend upwards from the heel end, as well as a ball striking face with a first surface roughness measurement for Ra within a few μinch of 180 μinch and a second surface roughness measurement for Ry within a few μinch of 1000 μinch. Preferably, the club head is a wedge-style club head. The club head complies with rules for golf from a golf association.

In some embodiments, the main club head body comprises a first material and the ball striking face comprises a second material. The ball striking face may be connected to the club head body by a method such as welding; adhesives; swaging; screws; and a press fit. In certain embodiments, the club head body and the ball striking face are monolithically formed of a single piece of material.

### BRIEF DESCRIPTION OF THE DRAWINGS

FIG. 1A illustrates how Ra is calculated.

FIG. 1B shows how Ry may be determined.

FIG. 2 illustrates a profile of a surface milled by prior art methods.

FIG. 3 illustrates a profile of a milled surface as provided by the invention.

FIG. 4 illustrates a typical vertical milling machine.

FIG. 5 depicts a vertical milling machine for numeric control.

FIG. 6 diagrams a method according to embodiments of the invention.

FIG. 7 shows a golf club made with a ball-striking face of the invention.

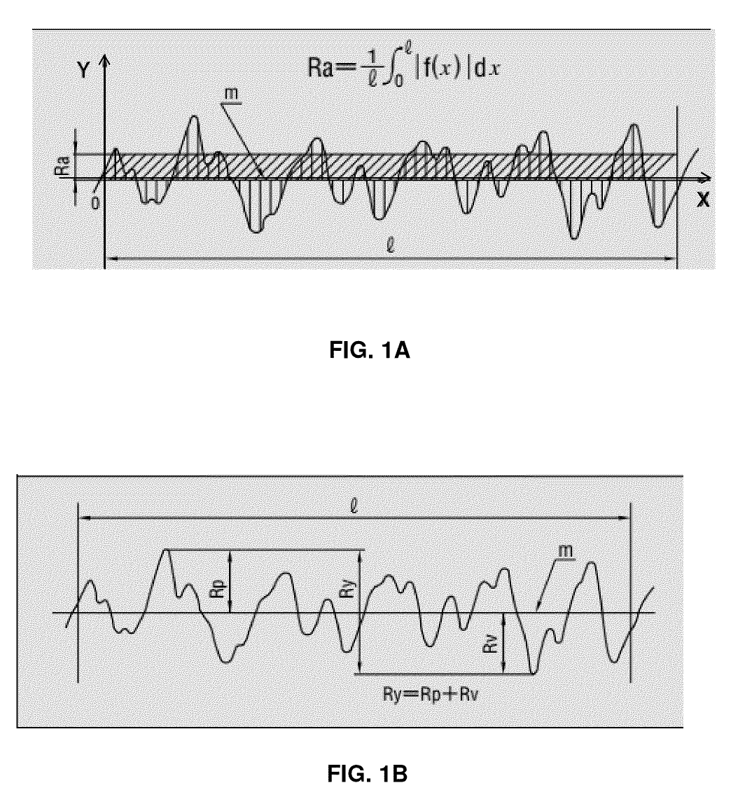

### DETAILED DESCRIPTION

The present invention provides a technique for milling the face of the club with two different cutting speeds. In certain embodiments, a club face is milled with a first speed equal to the current industry standard speed, and a second speed slower than the industry standard speed. This dual speed cutting approach causes a mixture of large mill marks and small mill marks. This allows for larger mill marks than would be achievable with a constant cutting speed because they are numerically averaged with the smaller mill marks. The provided technique gives optimal levels of Ra and Ry.

Milling is a mechanical process of using rotary cutters to remove material from a workpiece as it is advanced in a direction at an angle with the axis of the tool. In general, milling operates on the principle of rotary motion. A milling cutter is spun about an axis while a workpiece is advanced through it in such a way that the blades of the cutter are able to shave chips of material with each pass.

Milling processes make many individual cuts on the material in a single run using a cutter with many teeth. The number of density of teeth is characterized as pitch. The cutter is spun at high speed, and material generally advances through the cutter slowly. The speed at which the piece advances through the cutter may be called the feed rate.

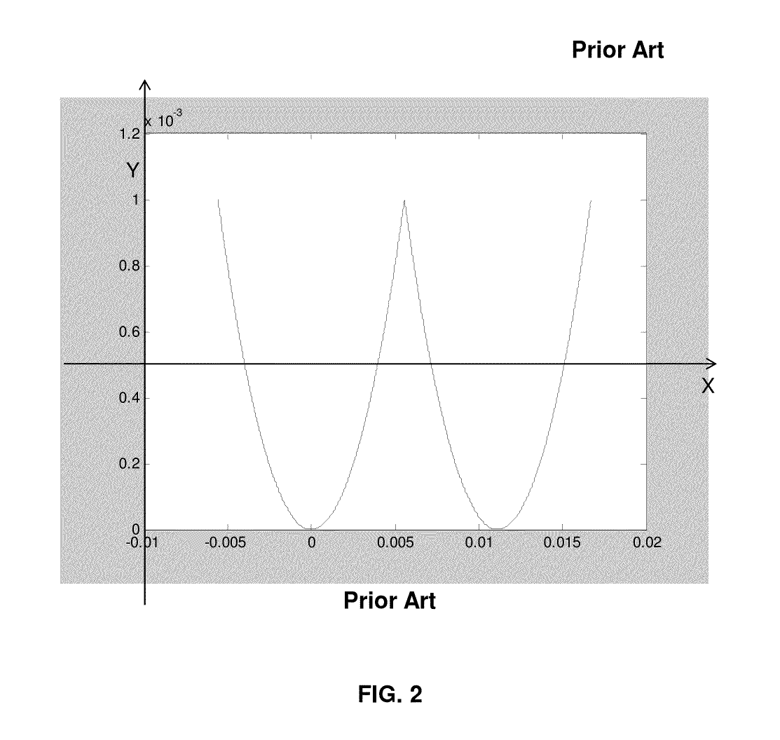

FIG. 2 illustrates a profile of a milled to Ry of 1000 μinch by prior art methods. The depicted profile is a result of typical prior art machining. Prior art processes involved a constant feed rate and single depth of cut. To obtain the Ry of 1000 μinch, the prior art process required the work piece to be milled to the point that Ra became 277 μinch, which is exhibited by the profile shown in FIG. 2, and does not conform with golf rules that prohibit Ra from exceeding 180 μinch and Ry from exceeding 1000 μinch.

The invention contains the insight that a different profile can provide a club head with a strike face Ry at or approaching 1000 μinch that also conforms with golf rules that prohibit Ra from exceeding 180 μinch and prohibit Ry from exceeding 1000 μinch.

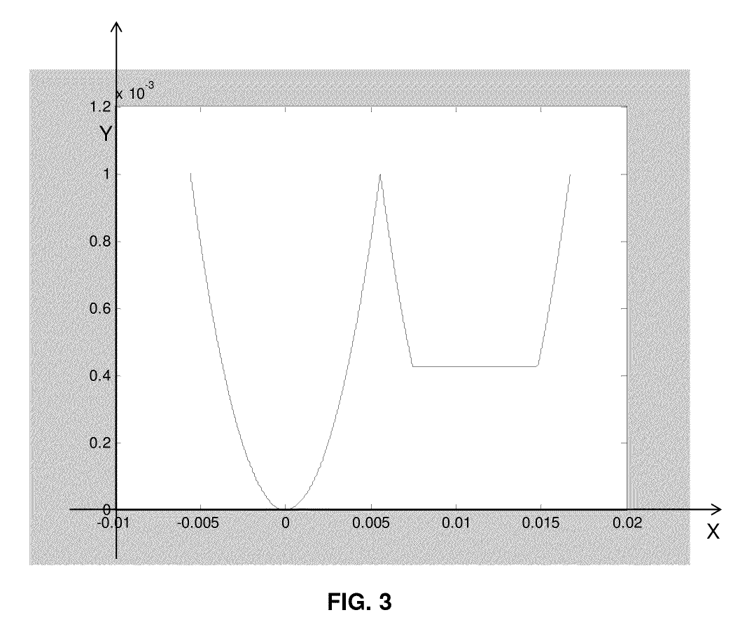

FIG. 3 illustrates a profile of a milled surface as provided by the invention. The depicted surface has an Ra of 180 μinch and an Ry of 1000 μinch. The profile depicted in FIG. 3 may be obtained by a dual speed machining process. The process can use variable feed rate to provide two depths of cut.

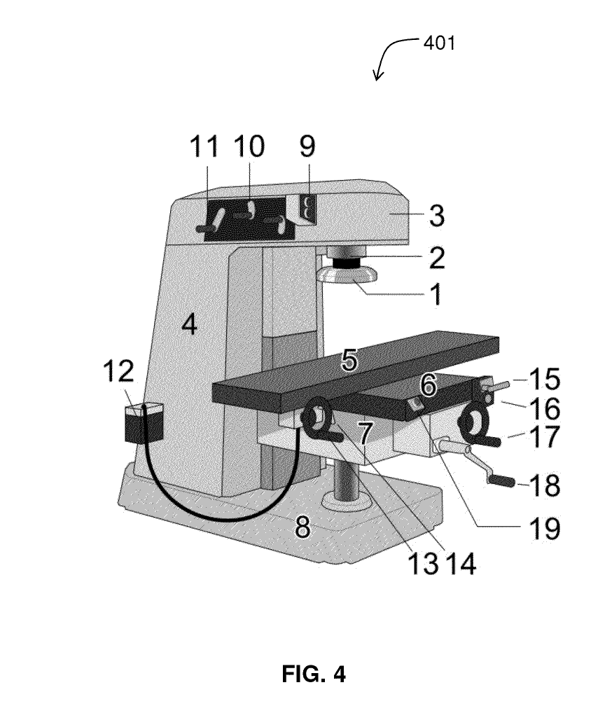

FIG. 4 illustrates a typical vertical milling machine 401 and its components. Milling machine 401 includes a milling cutter 1 mounted on a spindle 2. A top slide 3 extends forward from column 4 over table 5. Machine 401 includes a y-axis slide 6 over a knee 7 mounted on base 8. Other features that may be included are spindle switch 9, spindle speed gear lever 10, spindle speed control lever 11, oil tank 12, table manual wheel 13, table lock bar 14, saddle automatic moving bar 15, saddle automatic moving control dial 16, saddle manual wheel 17, knee manual wheel 18, and quick button 19.

In a vertical mill, the spindle axis is vertically oriented. Milling cutter 1 is held in spindle 2 and rotates on an axis of the spindle. Spindle 2 can generally be extended (or the table can be raised/lowered, giving the same effect), allowing plunge cuts and drilling. There are two subcategories of vertical mills: the bed mill and the turret mill.

A turret mill has a stationary spindle and the table is moved both perpendicular and parallel to the spindle axis to accomplish cutting. Turret mills may have a quill which allows the milling cutter to be raised and lowered in a manner similar to a drill press. This type of machine provides two methods of cutting in the vertical (Z) direction: by raising or lowering the quill, and by moving knee 7. In the bed mill, table 5 moves perpendicular to the axis of spindle 2, while the spindle itself moves parallel to its own axis. Typically, larger milling machines are of the bed type and may be operated by a computerized control system.

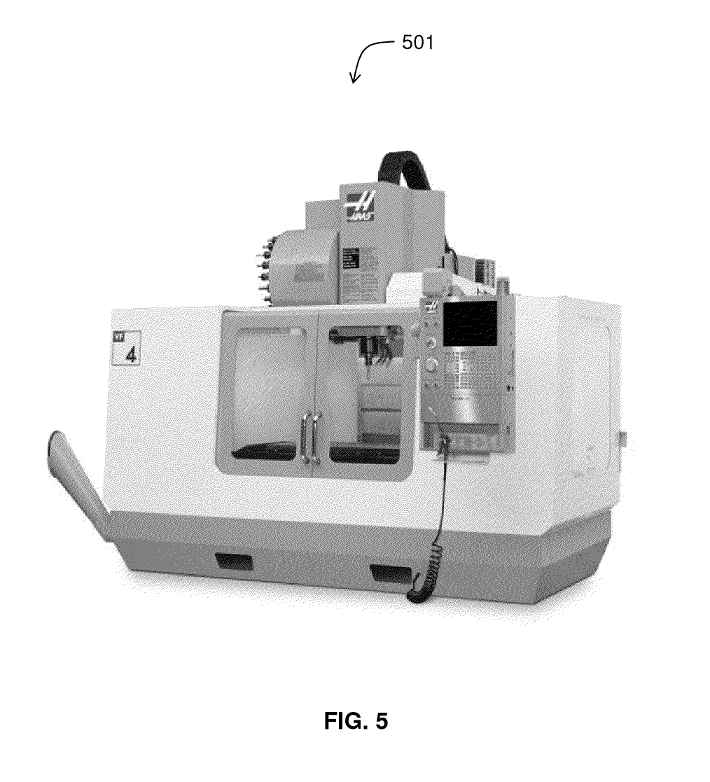

FIG. 5 depicts a vertical machining center capable of automation through the use of programmed commands encoded on a storage medium, also known as computer numeric control. Thus FIG. 5 depicts a CNC VMC 501 for use in methods of the invention. While one of skill in the art will understand that any of a number of suitable milling machines may be used for CNC VMC 501, an exemplary such machine is the Vertical Machining Center sold as Model VF-2 by Haas Automation, Inc. (Oxnard, Calif.).

Numerical control (NC) is the automation of machine tools that are operated by programmed commands encoded on a storage medium, as opposed to controlled manually via hand wheels or levers, or mechanically automated via cams alone. Most NC today is computer numerical control (CNC), in which computers play an integral part of the control.

In modern CNC systems, end-to-end component design may be automated using computer-aided design (CAD) and computer-aided manufacturing (CAM) programs. The programs produce a computer file that is interpreted to extract the commands needed to operate a particular machine via a postprocessor, and then loaded into the CNC machines for production. Since any particular component might require the use of a number of different tools—such as drills, saws, etc.—modern machines often combine multiple tools into a single “cell”.

Mills typically use a table 5 that moves in the X and Y axes, and a tool spindle 2 that moves in the Z (depth). The position of the tool is driven by motors through a series of step-down gears in order to provide highly accurate movements, or in modern designs, direct-drive stepper motor or servo motors.

An advanced CNC milling-machine, known as a multi-axis machine, may be used for methods described herein. A multi-axis machine may include additional (e.g., two) axes in addition to the three normal axes (XYZ). Some machines may have a C or Q axis, allowing the horizontally mounted workpiece to be rotated, essentially allowing asymmetric and eccentric turning. A fifth axis (B axis) controls the tilt of the tool itself. When all of these axes may be used in conjunction with each other, extremely complicated geometries, even organic geometries such as a human head can be made with relative ease with these machines. Typically, a 5-axis milling machines will be programmed with computer-aided manufacturing (CAM) tools.

Milling devices described herein may be used with known, standardized, or customized tooling systems. In general, the accessories and cutting tools used on milling machines are referred to in aggregate by the mass noun “tooling”. There is a high degree of standardization of the tooling used with CNC milling machines, and a lesser degree with manual milling machines.

Many CNC milling machines use SK (or ISO), CAT, BT or HSK tooling. SK tooling is common in Europe, while CAT tooling, sometimes called V-Flange Tooling, is common in the USA. CAT tooling was invented by Caterpillar Inc. of Peoria, Ill., in order to standardize the tooling used on their machinery. CAT tooling comes in a range of sizes designated as CAT-30, CAT-40, CAT-50, etc. The number refers to the Association for Manufacturing Technology (formerly the National Machine Tool Builders Association (NMTB)) Taper size of the tool.

A milling device may also use BT Tooling. Like CAT Tooling, BT Tooling comes in a range of sizes and uses the same NMTB body taper. However, BT tooling is symmetrical about the spindle axis, which CAT tooling is not. This gives BT tooling greater stability and balance at high speeds. One other subtle difference between these two tool-holders is the thread used to hold the pull stud. CAT Tooling uses Imperial thread and BT Tooling uses Metric thread.

In practice, the workpiece material is loaded into the milling machine. The workpiece is a material selected for inclusion in the final golf club strike face. Any suitable material may be used to make a golf club strike face including metals, polymers, composites, and other materials. Examples in include steel, aluminum, titanium, alloys, plastics, carbon fiber, or any other material. In certain embodiments, a golf club face is made from 303 stainless steel.

Using a CNC VMC 501, the computer program is selected and the machine is set to operate. The work piece is loaded into the mill, which is programmed according to the manufacturer's instructions. The machine spindle spins the milling cutter while the table advances the workpiece material through the cutting area.

As material passes through the cutting area of a milling machine, the blades of the cutter take swarfs of material at regular intervals. The cutting operation produces revolution marks and cuts into the material creating the roughness on the surface. The mill then operates automatically, according to the programming. The invention provides guidelines for programming the mill to obtain optimized surface roughness on a golf club head ball contact face.

For a point of comparison, a prior art machining procedure may include programming the mill to operate at a feed rate of 12 inches per minute, with a spindle speed of 1270 rpm, and a 0.07 inch pitch on the cutting blade. That prior art programming provides the Ra and Ry values after face milling given in Table 1.

TABLE 1
Surface roughness measurements (Ra and Ry) on workpiece
milled according to prior art procedure.

| | After Face Milling | |
|---|---|---|
| Sample # | Ra | Ry |
| 1 | 179 | 799 |
| 2 | 177 | 758 |
| 3 | 177 | 793 |
| 4 | 180 | 793 |
| 5 | 181 | 771 |
| 6 | 167 | 758 |
| 7 | 177 | 769 |
| 8 | 172 | 749 |
| 9 | 168 | 736 |
| 10 | 174 | 782 |
| Averages | 175 | 771 |

The invention gives a novel way to program the mill to optimize the roughness on the surface of a golf club head. The vertical milling machine is operated to change speeds. In general, methods of the invention include operating the mill at at least two different speeds on a single workpiece. Any systematic change in mill speed may be used that produces an optimized Ra and Ry. In certain embodiments, the mill is operated at a first setting, and then at a second setting. The first setting may include a feed rate of 12 inches per minute, a spindle speed of 1126 rpm, and a cutting wheel pitch of 0.0107 inch. The second setting may include a feed rate of 8.86 inches per minute, a spindle speed of 1126 rpm, and a cutting wheel pitch of 0.0079 inch. In a preferred embodiment, the mill is changed, alternating between the first setting and the second setting, as it traverses over every 0.039 inches of the ball striking face. When milled according to the preferred embodiments, and done ten different times, the process according to methods of the invention gave ten samples (numbered 1-10) with Ra and Ry values as shown in Table 2.

TABLE 2
Surface roughness measurements made on ten different golf club
head ball striking faces made using methods of the invention.

| | After Face Milling | |
|---|---|---|
| Sample # | Ra | Ry |
| 1 | 151 | 842 |
| 2 | 167 | 879 |
| 3 | 163 | 863 |
| 4 | 168 | 900 |
| 5 | 162 | 875 |
| 6 | 162 | 872 |
| 7 | 171 | 893 |
| 8 | 161 | 865 |
| 9 | 164 | 870 |
| 10 | 161 | 838 |
| Averages | 163 | 870 |

For the striking faces made with methods of the invention, as shown in Table 2, the Ra average is lower and the Ry average is higher than for the striking face made according to the prior art methods, as shown in Table 1. Using the prior art cutting process, Ra approaches the limit while the Ry is more than 200 μinch shy of the limit, as shown in Table 1.

Methods of the invention allow the depth of cut to be increased to achieve an Ra of 180 and an Ry of 1000. Simply increasing the depth of cut using the standard process would push Ra over the limit without maximizing Ry.

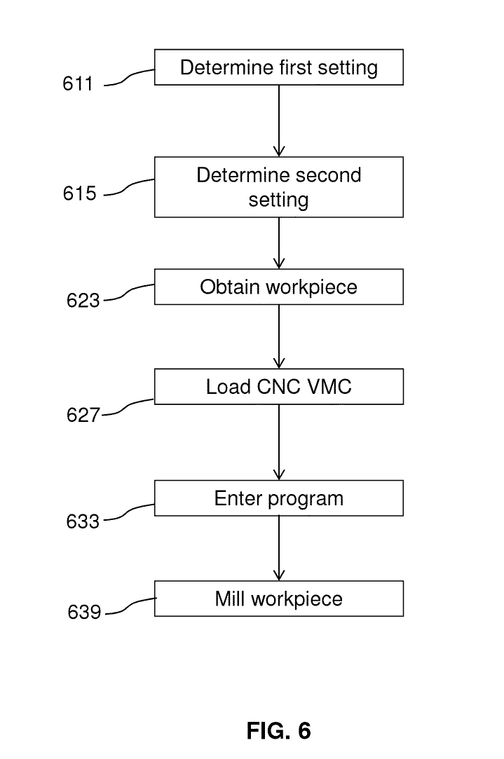

FIG. 6 diagrams a method according to embodiments of the invention. To make a golf club with a ball-striking face that has an optimized surface roughness, at least two different speed settings for a milling machine are selected. A first setting is determined in step 611. The listed steps need not be performed in the listed order. The first setting could include, for example, a feed rate of 12 inches per minute, a spindle speed of 1126 rpm, and a cutting wheel pitch of 0.0107 inch. A second setting is determined at step 615. The second setting may include a feed rate of 8.86 inches per minute, a spindle speed of 1126 rpm, and a cutting wheel pitch of 0.0079 inch. A workpiece that embodies a material to be used in the finished club head ball striking face is obtained at step 623. The workpiece is loaded into a CNC VMC at step 627. Any suitable milling machine may be used. For example, one suitable machine is the Vertical Machining Center sold as Model VF-2 by Haas Automation, Inc. (Oxnard, Calif.). The machine is programmed by entering a program at step 633 using the CNC control module. This will typically be accomplished by interacting with a computer device, which may be a “built-in”—i.e., part of machine 501—or may be a free-standing computer device. Typically, a computing device will include a processor coupled to a tangible, non-transitory memory capable of storing program instructions for execution by the processor to cause the milling system to perform steps described herein. For example, at step 639, the workpiece is milled by machine 501. The CNC control module causes machine 501 to alternate between the first setting and the second setting according to the program instructions entered at step 633. By milling the workpiece according to those instructions, machine 501 can turn out a golf club head ball-striking face that has Ra approaching 180 and Ry approaching 1000. For example, a ball-striking face can be made having properties listed for any of the samples shown in Table 2. Once the ball-striking face is made, it is assembled into a golf club.

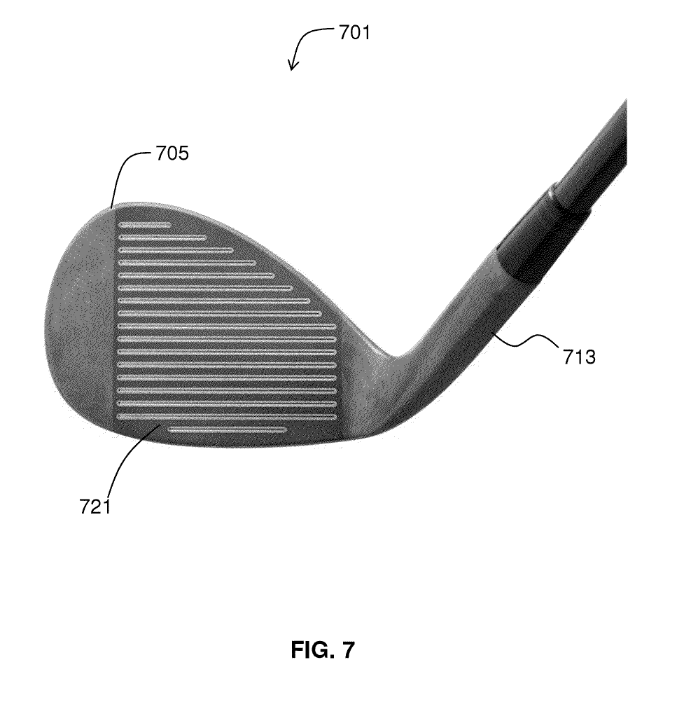

FIG. 7 shows a golf club 701 made with a ball-striking face of the invention. Club head 701 has a main club head body 705 characterized by a heel-end and a toe-end, as well as a front side with a ball striking face and a back side. Club head 701 includes a hosel extending up from the heel side for attachment to a shaft. Club head 701 further includes a ball striking face 721 manufactured by methods of the invention. Ball striking face 721 has an optimized surface roughness. For example, ball striking face 721 may have an Ra of about 163 and an Ry of about 870. Ball striking face 721 can be monolithically formed with club head body 705 or can be a separate piece attached to the body. Club head 701 is depicted as a wedge, but may be any style of club head including, for example, a putter, wedge, iron, hybrid, or wood-type club head. In a preferred embodiment, club head 701 is a wedge, such as a pitch wedge, a sand wedge, a lob wedge, or a gap wedge.

Any suitable method can be used to attach the ball striking face to the club. For example, a club head can be monolithically formed, and the disclosed milling process of the present invention can be performed on the front face of the club head. Alternatively, a separate face insert piece may be attached to the club head by, for example, welding, swaging, a tongue-and-groove attachment, a dovetail attachment, mechanical fasteners such as screws, adhesives, press-fit, bendable feet, or any other suitable attachment method. Exemplary methods of attaching a face insert to a club head are discussed in U.S. Pat. No. 8,491,412; U.S. Pat. No. 8,485,918; U.S. Pat. No. 8,480,512; U.S. Pat. No. 8,172,698; U.S. Pat. No. 7,811,179; U.S. Pat. No. 7,811,180; U.S. Pat. No. 7,588,503; U.S. Pub. 2004/0157677; and U.S. Pub. 2003/0153397, the contents of each of which are incorporated by reference for all purposes.

As used herein, the word “or” means “and or or”, sometimes seen or referred to as “and/or”, unless indicated otherwise.

### INCORPORATION BY REFERENCE

References and citations to other documents, such as patents, patent applications, patent publications, journals, books, papers, web contents, have been made throughout this disclosure. All such documents are hereby incorporated herein by reference in their entirety for all purposes.

### EQUIVALENTS

Various modifications of the invention and many further embodiments thereof, in addition to those shown and described herein, will become apparent to those skilled in the art from the full contents of this document, including references to the scientific and patent literature cited herein. The subject matter herein contains important information, exemplification and guidance that can be adapted to the practice of this invention in its various embodiments and equivalents thereof.

What is claimed is:

1. A method of making a golf club face, the method comprising:
obtaining a piece of material for use as a club head ball-striking face;
milling a surface of the piece of material at a first speed; and
milling the surface at a second speed.

2. The method of claim 1, further comprising programming a milling device to operate a first setting that includes the first speed and to operate at a second setting that includes the second speed.

3. The method of claim 2, wherein the milling steps comprising feeding the piece of material into the milling device and operating the milling device according to a program.

4. The method of claim 3, wherein the program causes the milling device to alternate between the first speed and the second speed a plurality of times.

5. The method of claim 4, further comprising using the milled piece of material as a ball-striking face in a club head.

6. The method of claim 5, wherein the club head is for a wedge style golf club.

7. The method of claim 6, wherein the ball striking face is a face insert that is attached to a club head body.

8. A golf club head comprising a ball striking face made by the method described in claim 1.

9. A golf club head comprising:
a main club head body having a heel end, a toe end, and a hosel extend upwards from the heel end, and
a ball striking face with a first surface roughness measurement for Ra within a few μinch of 180 μinch and a second surface roughness measurement for Ry within a few μinch of 1000 μinch.

10. The club head of claim 9, wherein the club head is a wedge-style club head.

11. The club head of claim 9, wherein the club head complies with rules for golf from a golf association.

12. The golf club head of claim 9, wherein the main club head body comprises a first material and the ball striking face comprises a second material.

13. The golf club head of claim 12, wherein the ball striking face is connected to the club head body by a method selected from the list consisting of: welding; adhesives; swaging; screws; and a press fit.

14. The golf club head of claim 9, wherein the club head body and the ball striking face are monolithically formed of a single piece of material.
